(19) United States
(12) Patent Application Publication
(10) Pub. No.: US 2017/0091777 A1
(43) Pub. Date: Mar. 30, 2017

(54) HELP CENTER THAT MODIFIES INTERACTION WITH A USER BASED ON ASSESSED EXPERTISE OF THE USER

(71) Applicant: International Business Machines Corporation, Armonk, NY (US)

(72) Inventors: Michael Bender, Rye Brook, NY (US); David E. Nachman, Morristown, NJ (US); Michael P. Shute, Niantic, CT (US)

(21) Appl. No.: 14/863,643

(22) Filed: Sep. 24, 2015

(51) Int. Cl. G06Q 30/00; G06Q 10/06; H04L 29/08

(52) U.S. Cl. CPC G06Q 30/016; H04L 67/306; G06Q 10/06316

(57) ABSTRACT

A help center uses a script to provide support to users, and includes a mechanism for assessing expertise of each user and dynamically modifying the flow through the script to provide better support to more expert users. The expertise of the user may be determined based on any or all of the following: past interactions with the help center; reputation of the user on social media; endorsement from other users; the user's organizational hierarchy and job roles; other information available from public sources; and linguistic cues given by the user. By assessing the expertise of the user and modifying the flow through the script according to the user's expertise, more experienced users will have a more streamlined experience and will more quickly get the support they need from the help center.

### BACKGROUND

1. Technical Field

This disclosure generally relates to help centers, and more specifically relates to a way of customizing a user's interaction with a help center based on the user's expertise.

2. Background Art

Help centers are often used to provide technical support. Most help centers use scripts of questions and prompts to provide the needed technical support to a user. Help centers may include call centers where a user calls on the telephone for technical support, or a website that provides an automated tool that prompts the user. Whether phone-based or web-based, most help centers function according to defined scripts that determine the interaction with the user. Because help centers must be able to help relatively inexperienced users, the scripts provide questions and prompts to help an inexperienced user get the support he or she needs. But more experienced users can quickly become frustrated at being asked questions and given prompts that are for far less experienced users. In addition, it takes time to go through the part of the script intended for less experienced users, which wastes the time of a more experiences user that does not need these prompts.

### SUMMARY

A help center uses a script to provide support to users, and includes a mechanism for assessing expertise of each user and dynamically modifying the flow through the script to provide better support to more expert users. The expertise of the user may be determined based on any or all of the following: past interactions with the help center; reputation of the user on social media; endorsement from other users; the user's organizational hierarchy and job roles; other information available from public sources; and linguistic cues given by the user. By assessing the expertise of the user and modifying the flow through the script according to the user's expertise, more experienced users will have a more streamlined experience and will more quickly get the support they need from the help center.

The foregoing and other features and advantages will be apparent from the following more particular description, as illustrated in the accompanying drawings.

### BRIEF DESCRIPTION OF THE DRAWING(S)

The disclosure will be described in conjunction with the appended drawings, where like designations denote like elements, and:

FIG. 1 is a block diagram of a computer system that includes a help center application that assesses expertise of a user and alters flow through scripts based on the expertise of the user;

FIG. 2 is a flow diagram of a method for a help center to provide better support to a user based on expertise of the user;

FIG. 3 is a block diagram showing sample user profiles;

FIG. 4 is a flow diagram of a method for defining suitable branch points in a script according to expertise of a user;

FIG. 5 is a flow diagram of a method for altering flow through a help center script based on expertise of the user;

FIG. 6 is a block diagram showing a sample help center script with branch points defined according to expertise of a user; and

FIG. 7 is a flow diagram of a method for determining expertise of a user.

### DETAILED DESCRIPTION

The disclosure and claims herein relate to a help center that uses a script to provide support to users. The help center includes a mechanism for assessing expertise of each user and dynamically modifying the flow through the script to provide better support to more expert users. The expertise of the user may be determined based on any or all of the following: past interactions with the help center; reputation of the user on social media; endorsement from other users; the user's organizational hierarchy and job roles; other information available from public sources; and linguistic cues given by the user. By assessing the expertise of the user and modifying the flow through the script according to the user's expertise, more experienced users will have a more streamlined experience and will more quickly get the support they need from the help center.

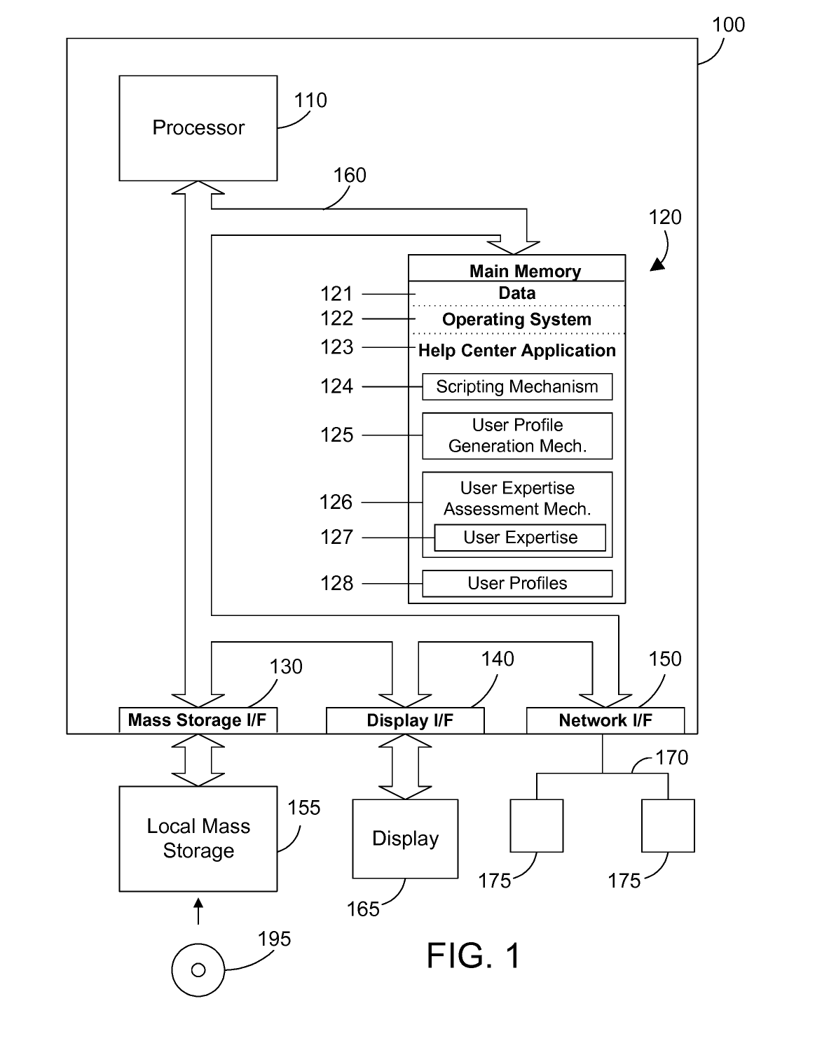

Referring to FIG. 1, a computer system 100 is one suitable implementation of a server computer system that includes a help center application that alters flow through a help center script according to expertise of the user. Server computer system 100 is an IBM zEnterprise System computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as local mass storage device 155, to computer system 100. One specific type of local mass storage device 155 is a readable and writable CD-RW drive, which may store data to and read data from a CD-RW 195.

Main memory 120 preferably contains data 121, an operating system 122, and a help center application 123. Data 121 represents any data that serves as input to or output from any program in computer system 100. Operating system 122 is a multitasking operating system. Help center application 123 is a software application that determines how a help center interacts with users. Help center application 123 preferably includes a scripting mechanism 124, a user profile generation mechanism 125, a user expertise assessment mechanism 126, and user profiles 128. The scripting mechanism 124 is used to generate and alter scripts that define how support is provided to users by the help center application 123. For a telephone help center, scripting mechanism 124 defines a list of prompts for the person at the telephone help center to provide to the user. For a web-based help center, scripting mechanism 124 defines a list of prompts given to the user on the user's computer according to answers the user provides. The disclosure and claims herein extend to telephone help centers, web-based help centers, or another other suitable type of help center that provides support to users based on scripts. The term “script” is used herein broadly to mean any sequence of questions, instructions or prompts that are provided by a help center to a user.

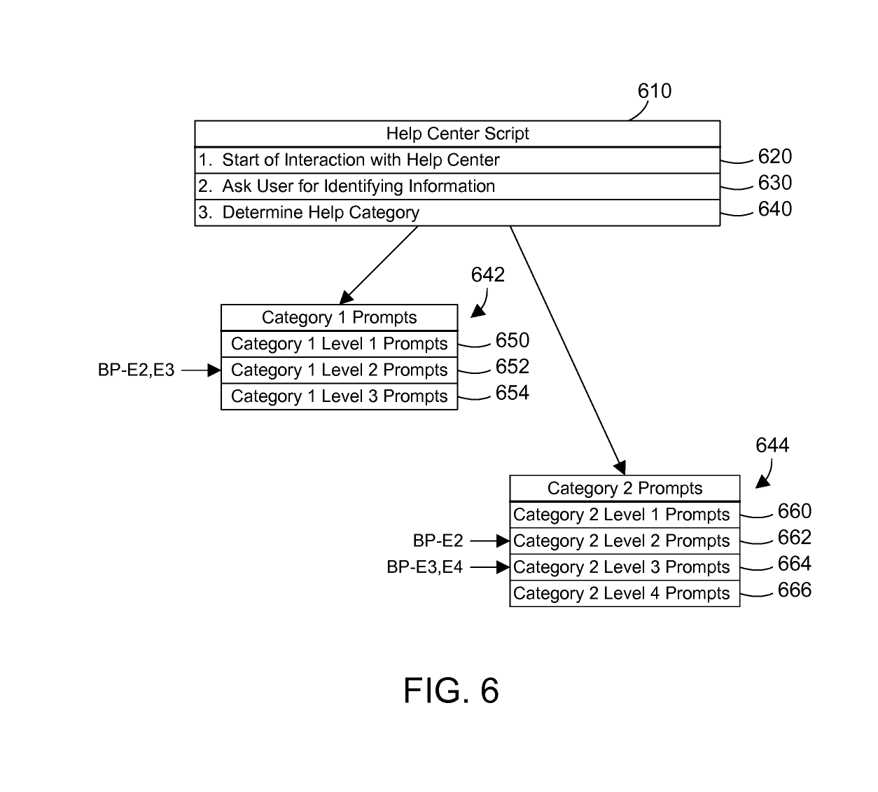

The user profile generation mechanism 125 is used to create a new user profile 128 when a user accesses the help center for the first time. The user profile generation mechanism 125 also can be used to update an existing user profile 128 according to information available from a variety of different private and public sources, as discussed in more detail below. The user expertise assessment mechanism 126 assesses user expertise 127 based on information in a user profile 128, and can additionally assess user expertise 127 based on information available from any suitable data source. The help center application uses the user expertise 127 to determine whether or not to alter flow through a script based on the user expertise 127. For example, when a user has expertise greater than other users, portions of the script that are intended for less-expert users may be skipped. Examples of skipping portions of the script are provided in FIG. 6 and are discussed in more detail below.

Computer system 100 utilizes well known virtual addressing mechanisms that allow the programs of computer system 100 to behave as if they only have access to a large, contiguous address space instead of access to multiple, smaller storage entities such as main memory 120 and local mass storage device 155. Therefore, while data 121, operating system 122, and help center application 123 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Processor 110 also executes the help center application 123.

Although computer system 100 is shown to contain only a single processor and a single system bus, those skilled in the art will appreciate that a help center application may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allow communicating on the network 170. Software in the network interface 150 preferably includes a communication manager that manages communication with other computer systems 175 via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 150.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

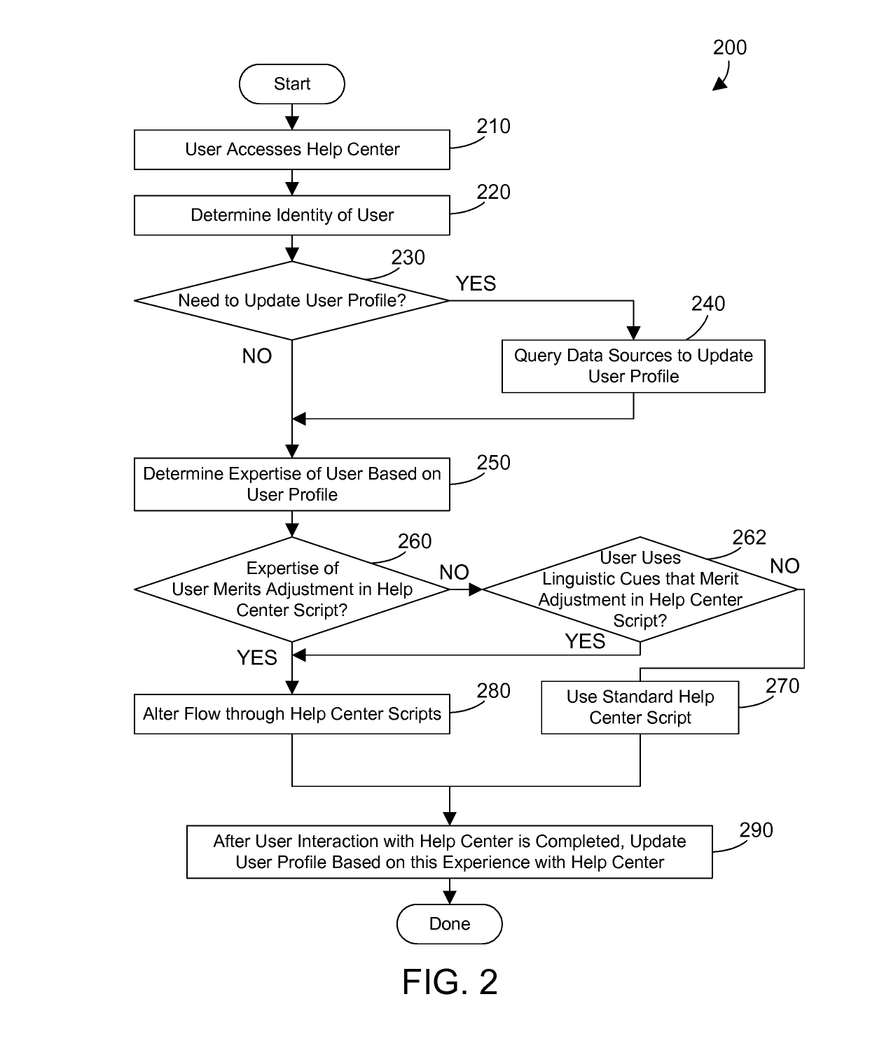

Referring to FIG. 2, a method 200 represents how a user interacts with a help center in accordance with the disclosure and claims herein. A user accesses the help center (step 210). For example, a user could access a help center via telephone, or could access an on-line help center. Of course, the disclosure herein expressly extends to any type of help center, whether currently known or developed in the future. The identity of the user is determined (step 220). For a telephone help center, this step includes the operator at the telephone help center asking the user for identifying information. For a web-based help center, this step includes prompting the user to enter identifying information in a form displayed to the user. When there is a need to update a user profile corresponding to the user (step 230=YES), multiple data sources are queried to update the user profile (step 240). If the help center does not have a user profile for this user, the need to update the user profile (step 230=YES) will be a need to initially create the user profile. In this case, the data sources are queried in step 240 to initially create the user profile for the user. Expertise of the user is determined based on the user profile (step 250). When the expertise of the user does not merit adjustment in the help center script (step 260=NO), and the user does not use linguistic cues that merit adjustment in the help center script (step 262=NO), the help center uses the standard help center script to interact with the user (step 270). When the expertise of the user merits adjustment in the help center script (step 260=YES), the flow through the help center scripts is altered (step 280). Even when the expertise of the user does not merit an adjustment in the help center script (step 260=NO), if the user uses certain defined linguistic cues that merit adjustment in the help center script (step 262=YES), the flow through the help center scripts is altered (step 280). After the user interaction with the help center is completed, the user profile corresponding to the user is updated based on this experience with the help center (step 290). The updating in step 290 could be done automatically by the help center application based on defined metrics for measuring expertise of the user. When the help center application is prompting a person in the help center to provide prompts to the user, after the user interaction with the help center is completed, the person in the help center could fill out a form with various questions to help better determine the expertise for the user. Method 200 is then done.

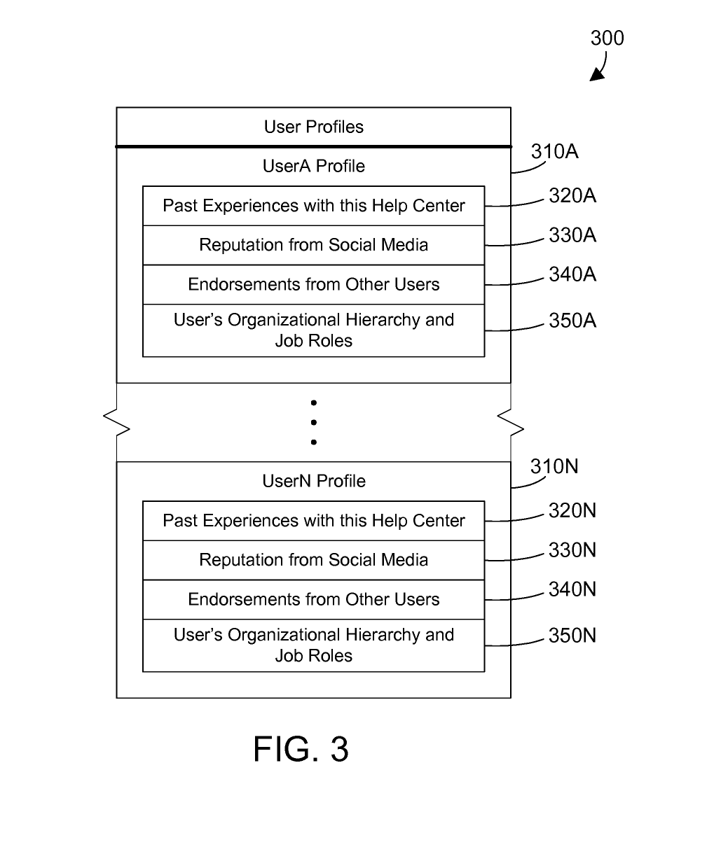

Sample user profiles are shown in FIG. 3. User profiles 300 are specific implementations for the user profiles 128 shown in FIG. 1. User profiles 300 include multiple profiles 310A, . . . , 310N, with each user profile corresponding to a different user. Each user profile preferably includes past experiences with this help center, reputation from social media, endorsements from other users, and a user's organizational hierarchy and job roles. Thus, UserA Profile 310A includes past experiences with this help center 320A, reputation from social media 330A, endorsements from other users 340A, and a user's organization hierarchy and job roles 350A. Similarly, UserN Profile 310N includes past experiences with this help center 320N, reputation from social media 330N, endorsements from other users 340N, and a user's organization hierarchy and job roles 350N. By storing this information in a user's profile, this information can be used to assess the expertise of the user when the user accesses the help center to customize the user's experience with the help center according to the user's assessed expertise.

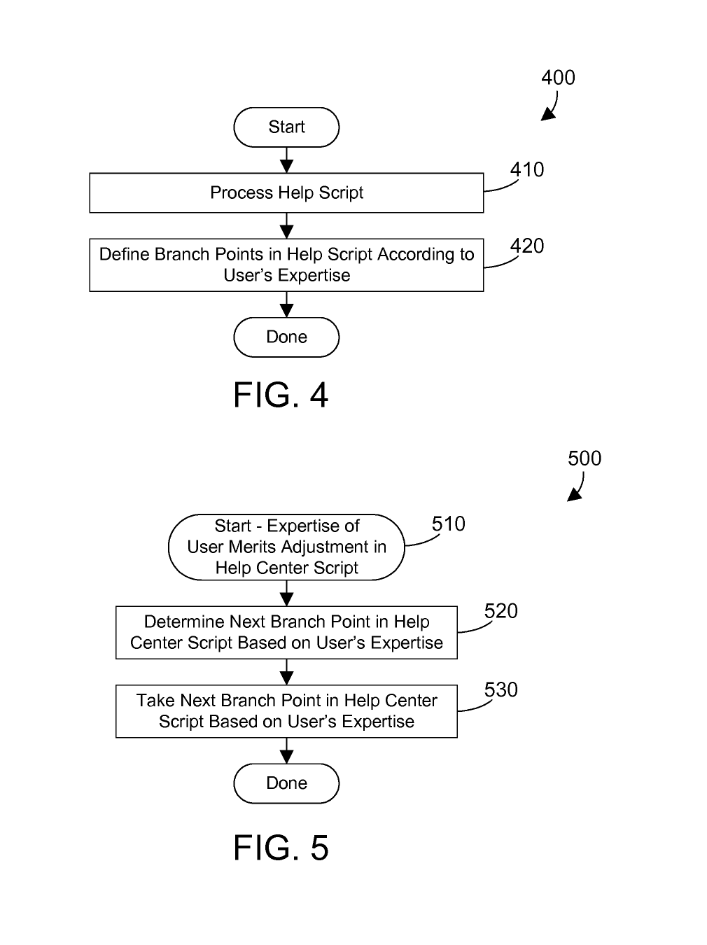

For a help center to customize a user's experience based on the user's expertise, the help center scripts will be modified to accommodate different levels of user expertise. Referring to FIG. 4, method 400 begins by processing a help script (step 410). Branch points in the help script are defined according to the user's expertise (step 420). Method 400 is then done.

FIG. 5 shows a method 500 for customizing a user's experience with a help center based on the user's expertise. FIG. 500 in FIG. 5 starts when the expertise of the user merits adjustment in the help center script (step 510). Note this corresponds to step 260=YES in FIG. 2. The next branch point in the help center script based on the user's expertise is determined (step 520). The next branch point in the help center script based on the user's expertise is taken (step 530). A simple example is shown in FIG. 6 to illustrate the concepts in FIGS. 4 and 5.

An example help center script 610 is shown in FIG. 6. Step 1 620 is the start of a user interacting with the help center. Step 2 630 is a prompt that asks the user for identifying information. Step 3 640 determines a help category. Based on the user's input, one of the two categories 642 and 644 in FIG. 6 is selected. Category 1 Prompts 642 include three different levels of prompts 650, 652 and 654. In the prior art, the help center would prompt the user with the Category 1 Level 1 Prompts, followed by the Category 1 Level 2 Prompts, followed by the Category 1 Level 3 Prompts. But using method 400 in FIG. 4, the help center script 610 is analyzed, and a branch point (BP-E2,E3) is created that allows users with expertise levels E2 or E3 to skip the Category 1 Level 1 Prompts 650 and start with the Category 1 Level 2 Prompts 652. In similar fashion, two branch points BP-E2 and BP-E3,E4 are defined in the Category 2 Prompts 644. The BP-E2 branch point allows a user with expertise level E2 to skip the Category 2 Level 1 Prompts 660 and start instead with the Category 2 Level 2 Prompts 662. The BP-E3,E4 branch point allows a user with expertise level E3 or E4 to skip the Category 2 Level 1 Prompts 660 and the Category 2 Level 2 Prompts 662 and start instead with the Category 2 Level 3 Prompts 664. Note the prompts and levels of expertise in FIG. 6 are intentionally abstract to represent that any suitable number or types of branch points could be inserted based on any suitable numbers and levels of user expertise. One skilled in the art will recognize the principles in FIGS. 4 and 6 could be applied to any type of help center script to define any suitable number or types of branch points based on any suitable level of user expertise.

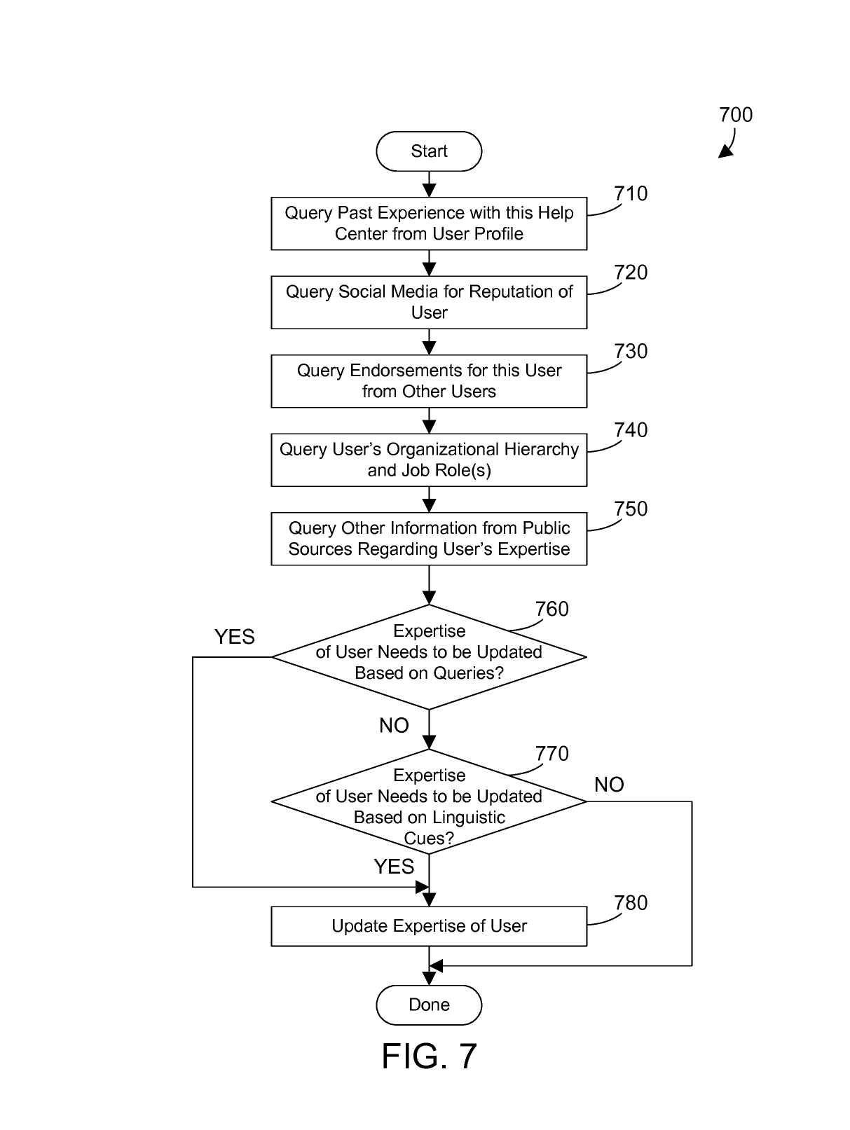

Referring to FIG. 7, a method 700 represents one suitable implementation for step 240 in FIG. 2. The past experience with this help center is queried (step 710). The past experience with this help center is preferably stored in the user profile corresponding to the user. Social media is queried to determine reputation of the user (step 720). Any type of social media cited could be queried, whether currently known or developed in the future. Endorsements for this user from other users are queried (step 730). Endorsements could come from any suitable data source, whether private or public. For example, a company such as IBM could maintain a database of endorsements from engineers in the company for other engineers in the company. In this case, the query in step 730 by an IBM help center could access the IBM internal database regarding endorsements. In the alternative, endorsements could come from any suitable public source. For example, LinkedIn is a professional social media website that allows users to endorse other users. So LinkedIn could be accessed in step 720 to determine reputation of the user, and could be accessed again in step 730 to determine endorsements for this user from other users. A user's organizational hierarchy and job role(s) is queried (step 740). Once again, this could be from any suitable private or public data source. Using the example above for an IBM engineer accessing an IBM help center, the help center could query an internal IBM database that includes information regarding the user's organizational hierarchy and job role or roles. Of course, this information could also be accessed on any suitable public site, such as LinkedIn. Any other information available from public data sources may also be queried (step 750). Step 750 broadly includes the ability to access information regarding the user from any suitable website or other public database. When the queries in steps 710-750 provide information that indicates the expertise of the user needs to be updated (step 760=YES), the expertise of the user is updated (step 780) based on the queries. When the queries in steps 710-750 do not provide information that indicates the expertise of the user needs to be updated (step 760=NO), if the expertise of the user needs to be updated based on linguistic cues (step 770=YES), the expertise of the user is updated (step 780) based on the linguistic cues. If the expertise of the user does not need to be updated based on linguistic cues (step 770=NO), method 700 is done. Linguistic cues include any suitable language used by the user, including without limitation words, word stems, phrases, acronyms, etc.

Note that any of steps 710, 720, 730, 740 and 750 could be performed, but not all need to be performed. Any suitable subset of steps 710, 720, 730, 740 and 750 could be performed within the scope of the disclosure and claims herein. Note also that the information from the queries in steps 710, 720, 730, 740 and 750, could be stored in the user profile corresponding to the user, as shown in FIG. 2. When this is the case, step 240 that queries data sources to update the user profile could include querying the user profile. Note also an updated expertise based on linguistic cues could also be stored in the user profile corresponding to the user.

Various examples are now provided as use cases to illustrate how a help center application can modify interaction with a user based on assessed expertise of the user. Let's assume an experienced IT end user calls in with a problem that they claim is related to a particular piece of hardware. The help center person uses feedback gathered on their internal system to see ratings of the prior interactions of this help center with this user to determine that the caller is well versed in this type of hardware and has usually done the required diagnosis. The help center application adjusts the script to ask direct technical questions instead of walking the user through more basic questions. In a second use case, the help center person may manually switch to a more technical script based on linguistic keys from the user, such as the use of the correct technical jargon or buzzwords. In a third use case, a help center may examine social networks (such as Linked In, Facebook and Twitter) and other relevant reputation-aware sites (such as Stack Overflow) to use the end user's reputation score and activity to determine that they are more advanced and basic questions can be skipped. In a fourth use case, a help center may use references from other high reputation users to vouch for or endorse a user as being skilled in an area. For instance, if a user is calling a medical help desk line, the flow of the script may be changed if a nurse or doctor has endorsed the user as being an expert in a particular disease/medicine/etc. In a fifth use case, a help center may use an organization's hierarchy and job roles to assess expertise of a user. For example, if the user has a job role in a technical job family or is a supervisor of technical persons, the flow through the script may be modified to provide the user more complex questions. In a sixth use case, a user who is an IBM engineer calls the IBM help desk, which is a help center. Based on the user's phone number, the user is identified by the help center application as an IBM employee. The help center application accesses the internal IBM database and determines the user is an Expert Level Certified IT Specialist. The help center application than sees the user has a skill level 5 as related to DB2 and SQL. As the user goes through the standard questions, the user requests help with a database server. The help center application queries LinkedIn and sees the user also has expertise in Data Warehousing, but has never called the help desk before for database server problems. Based on the analysis by the help desk application, the user gets strong grades for skills and social network, but no score based on history with the help desk. We assume for this example the help center application gives the user a skill level 5 for internal references @ 40% weight, a skill level 4 based on social networks @ 10% weight, and 0 score for previous history on this topic with this call center. The user's call is directed to second level support with the user's skills displayed. The script is followed and after a few additional questions the user is transferred to third level support. Third level support resolves the problem and grades the user as a 4 on this topic. The following week the user calls back with a similar problem, and the additional input allows the help center application to modify the flow of the scripts so the user proceeds to third level support immediately. As the examples above show, one of the advantages of a help center application with the features disclosed herein is to expedite the process of getting a user to the correct person at the correct level, with the goal of reducing costs for the help center.

A help center uses a script to provide support to users, and includes a mechanism for assessing expertise of each user and dynamically modifying the flow through the script to provide better support to more expert users. The expertise of the user may be determined based on any or all of the following: past interactions with the help center; reputation of the user on social media; endorsement from other users; the user's organizational hierarchy and job roles; other information available from public sources; and linguistic cues given by the user. By assessing the expertise of the user and modifying the flow through the script according to the user's expertise, more experienced users will have a more streamlined experience and will more quickly get the support they need from the help center.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a help center application residing in the memory and executed by the at least one processor, the help center application comprising:
a scripting mechanism that provides a plurality of scripts for prompting a user of the help center application;
a user profile generation mechanism that generates a user profile for the user of the help center, wherein the user profile includes past experience with the help center application;
a user expertise assessment mechanism that analyzes information in the user profile for the user to determine expertise of the user; and
wherein the help center application alters at least one flow in the plurality of scripts based on the determined expertise of the user.

2. The apparatus of claim 1 wherein user profile for the user further comprises reputation of the user on social media.

3. The apparatus of claim 2 wherein the user profile for the user further comprises endorsements by other users for the user and job role for the user.

4. The apparatus of claim 1 wherein the user expertise assessment mechanism determines based on linguistic cues from the user to change the determined expertise of the user.

5. The apparatus of claim 1 wherein the scripting mechanism determines a plurality of branch points in the plurality of scripts that alter flow in the plurality of scripts based on expertise of users.

6. The apparatus of claim 1 wherein the user expertise assessment mechanism queries social media to determine the expertise of the user, queries a first data source to determine endorsements from other users for the user to determine the expertise of the user, and queries a second data source to determine organizational hierarchy and job roles of the user to determine the expertise of the user.

7. The apparatus of claim 1 wherein, after the user is done interacting with the help center application, the user expertise mechanism updates the user profile for the user based on interaction of the user with the help center application.

8. A computer-implemented method executed by at least one processor for a help center application to provide help to a user, the method comprising:
providing a plurality of scripts for prompting a user of the help center application;
generating a user profile for the user of the help center, wherein the user profile includes past experience with the help center application;
analyzing information in the user profile for the user to determine expertise of the user; and
altering at least one flow in the plurality of scripts based on the determined expertise of the user.

9. The method of claim 8 wherein user profile for the user further comprises reputation of the user on social media.

10. The method of claim 9 wherein the user profile for the user further comprises endorsements by other users for the user and job role for the user.

11. The method of claim 8 further comprising changing the determined expertise of the user based on linguistic cues from the user.

12. The method of claim 8 further comprising determining a plurality of branch points in the plurality of scripts that alter flow in the plurality of scripts based on expertise of users.

13. The method of claim 8 further comprising:
querying social media to determine the expertise of the user;
querying a first data source to determine endorsements from other users for the user to determine the expertise of the user; and
querying a second data source to determine organizational hierarchy and job roles of the user to determine the expertise of the user.

14. The method of claim 8 wherein, after the user is done interacting with the help center application, the user expertise mechanism updates the user profile for the user based on interaction of the user with the help center application.

15. An article of manufacture comprising software stored on a non-transitory computer readable storage medium, the software comprising a help center application comprising:
a scripting mechanism that provides a plurality of scripts for prompting a user of the help center application;
a user profile generation mechanism that generates a user profile for the user of the help center, wherein the user profile includes past experience with the help center application;
a user expertise assessment mechanism that analyzes information in the user profile for the user to determine expertise of the user; and
wherein the help center application alters at least one flow in the plurality of scripts based on the determined expertise of the user.

16. The article of manufacture of claim 15 wherein user profile for the user further comprises reputation of the user on social media.

17. The article of manufacture of claim 16 wherein the user profile for the user further comprises endorsements by other users for the user and job role for the user.

18. The article of manufacture of claim 15 wherein the user expertise assessment mechanism determines based on linguistic cues from the user to change the determined expertise of the user.

19. The article of manufacture of claim 15 wherein the user expertise assessment mechanism queries social media to determine the expertise of the user, queries a first data source to determine endorsements from other users for the user to determine the expertise of the user, and queries a second data source to determine organizational hierarchy and job roles of the user to determine the expertise of the user.

20. The article of manufacture of claim 15 wherein, after the user is done interacting with the help center application, the user expertise mechanism updates the user profile for the user based on interaction of the user with the help center application.
